(19) United States
(12) Patent Application Publication
(10) Pub. No.: US 2019/0085799 A1
(43) Pub. Date: Mar. 21, 2019

(54) INTAKE SYSTEM OF INTERNAL COMBUSTION ENGINE

(71) Applicant: Suzuki Motor Corporation, Hamamatsu-shi (JP)

(72) Inventor: Akihito FUKUI, Hamamatsu-shi (JP)

(73) Assignee: SUZUKI MOTOR CORPORATION

(21) Appl. No.: 16/137,125

(22) Filed: Sep. 20, 2018

(30) Foreign Application Priority Data
Sep. 21, 2017 (JP) 2017181170

(51) Int. Cl. F02M 35/10; F02M 35/16; F02M 35/024; F02M 35/116

(52) U.S. Cl. CPC F02M 35/10144; F02M 35/162; F02M 35/116; F02M 35/10255; F02M 35/10295; F02M 35/024

(57) ABSTRACT

To provide an intake system of an internal combustion engine that can improve rigidity of a throttle body by strengthening a connection between plural components having an intake passage and further stabilize the opening degree of the throttle body. An intake system of an internal combustion engine includes: a plurality of throttle body members, each having at least one intake passage; and a plurality of structural connectors that are provided on respective throttle body members and connect adjacent the throttle body members with each other. The plurality of structural connectors includes a pair of structural connectors that are connected with each other in directions different from each other.

### CROSS-REFERENCE TO RELATED APPLICATIONS

This application claims the benefit of priority of Japanese Patent Application No. 2017-181170, filed on Sep. 21, 2017, the entire contents of which are incorporated herein by reference.

### BACKGROUND OF THE INVENTION

### Field of the Invention

The present invention relates to an intake system of an internal combustion engine.

### Description of the Related Art

There is known a throttle body in which plural components having an air passage are combined. The conventional throttle body includes a right side component having the air passage and a left side component having the air passage (e.g., Japanese Unexamined Patent Application Publication No. 2010-59894).

The throttle body is vibrated by vibration propagating from the engine. The rigidity of the throttle body depends on the state of connection of the components having the air passage divided into a plurality of parts (i.e., right side component and left side component).

When the rigidity of the throttle body is insufficient, for instance, the throttle body largely vibrates due to vibration of the engine, and thus a gap between a valve seat and a valve body in the throttle body becomes unstable (i.e., changes from constant state to unstable state). Such a change in the gap between the valve seat and the valve body, i.e., the change in the opening degree of the throttle body makes the idling of the engine unstable, for instance.

### SUMMARY OF THE INVENTION

To solve the problem described above, it is an object of the present invention to provide an intake system of an internal combustion engine that can improve rigidity of a throttle body by strengthening a connection between plural components having an intake passage and further stabilize the opening degree of the throttle body.

To achieve the above object, an intake system of an internal combustion engine including: a plurality of throttle body members, each having at least one intake passage; and a plurality of structural connectors that are provided on respective throttle body members and connect adjacent the throttle body members with each other. The plurality of structural connectors includes a pair of structural connectors that are connected with each other in directions different from each other.

According to the present invention, it is possible to provide an intake system of an internal combustion engine that can improve rigidity of a throttle body by strengthening connection between plural components having an intake passage and further stabilize the opening degree of the throttle body.

### BRIEF DESCRIPTION OF THE DRAWINGS

In the accompanying drawings:

FIG. 1 is a left side view illustrating a motorcycle to which an intake system of an internal combustion engine according to an embodiment of the present invention is applied;

FIG. 2 is a longitudinal cross-sectional view of the intake system according to the embodiment of the present invention;

FIG. 3 is a plan view of a throttle body of the intake system according to the embodiment of the present invention;

FIG. 4 is a perspective view of the throttle body of the intake system according to the embodiment of the present invention;

FIG. 5 is a cross-sectional view of the throttle body of the intake system according to the embodiment of the present invention;

FIG. 6 is another cross-sectional view of the throttle body of the intake system according to the embodiment of the present invention;

FIG. 7 is a plan view illustrating an air cleaner of the motorcycle according to the embodiment of the present invention with a lid open; and

FIG. 8 is a perspective view of funnels of the air cleaner of the motorcycle according to the embodiment of the present invention.

### DETAILED DESCRIPTION

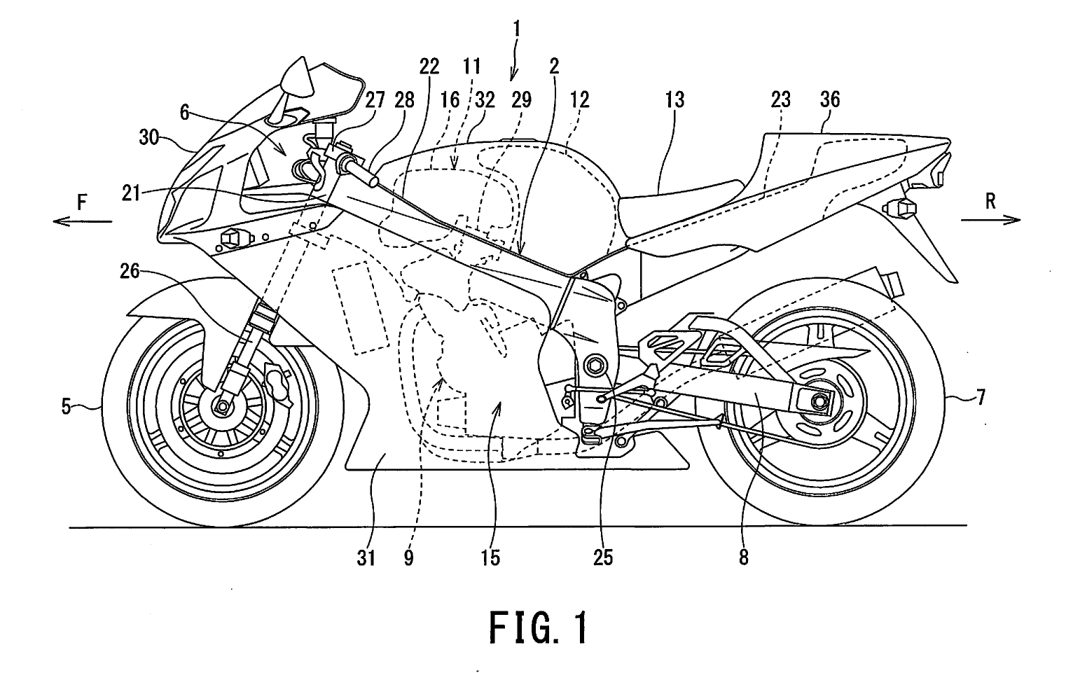

Hereinbelow, an embodiment of an intake system of an internal combustion engine according to the present invention will be described by referring to FIG. 1 to FIG. 8. The same reference signs are given for identical or equivalent components in each figure.

FIG. 1 is a left side view illustrating a motorcycle to which the intake system of the internal combustion engine according to the embodiment of the present invention is applied.

In the present embodiment, directional terms such as front, rear, upper, upward, lower, downward, right, and left are used with reference to a rider who rides on the motorcycle 1.

As shown in FIG. 1, the motorcycle 1 according to the embodiment of the present invention includes a body frame 2 that extends in the front-rear direction of the motorcycle 1, a front wheel 5 disposed in front of the body frame 2, a steering mechanism 6 that is disposed at the front end portion of the body frame 2 and rotatably supports the front wheel 5, a rear wheel 7 disposed behind the body frame 2, a swing arm 8 that is disposed at the rear of the body frame 2 and rotatably supports the rear wheel 7, and an internal combustion engine 9 (hereinafter simply referred to as the engine 9) mounted on the body frame 2.

The motorcycle 1 further includes an intake system 11 for purifying intake air (i.e., air sucked into the engine 9) and supplying an air-fuel mixture of a required flow rate to the engine 9, a fuel tank 12 for storing fuel to be supplied to the engine 9, a seat 13 for seating a rider, and a cowling 15 for covering at least a part of the body frame 2.

The body frame 2 is, e.g., a so-called cradle type.

The body frame 2 includes a steering head pipe 21 disposed at the front end of the body frame 2, a pair of right and left main frames 22 branching to the right and left immediately behind the steering head pipe 21 and extending rearward, and a pair of right and left seat rails 23 connected with the rear end of the main frames 22 and extending gently rearward.

The steering head pipe 21 steerably supports the steering mechanism 6.

The right and left main frames 22 are bent. That is, the right and left main frames 22 branch off immediately behind the steering head pipe 21 to widen the distance between the right and left main frames 22, and include an elongated straight portion gently sloping downward the rear of the motorcycle 1 and a short straight portion that is connected with the rear end portion of the elongated straight portion and extends downward. The right and left main frames 22 support the engine 9 disposed below the elongated straight portion and in front of the short straight portion so as to hold the engine 9. The right and left main frames 22 support the air cleaner 16 disposed above the front half of the elongated straight portion. The right and left main frames 22 support the fuel tank 12 above the rear half of the elongated straight portion. The right and left main frames 22 support a pivot shaft 25 extending in the vehicle width direction between both the short straight portions. The pivot shaft 25 swingably supports the swing arm 8.

The engine 9 is disposed behind the front wheel 5 and below the main frames 22, and occupies the central lower portion of the motorcycle 1. The engine 9 includes plural, e.g., four cylinders (not shown) arranged in the vehicle width direction of the motorcycle 1. That is, the engine 9 is a parallel multi-cylinder engine, e.g., a parallel four-cylinder engine.

The steering mechanism 6 includes a non-illustrated steering shaft penetrating the steering head pipe 21 and serving as the rotation center of the steering mechanism 6, a pair of right and left front forks 26 extending vertically, and handle bars 27 that are connected with the upper ends of the respective front forks 26 and extend to the right and left of the motorcycle 1.

The handle bars 27 are equipped with corresponding handle grips 28 to be grasped by a rider. The right handle grip 28 is a throttle grip.

The intake system 11 of the engine 9 includes an air cleaner 16 and a throttle body 29. The air cleaner 16 purifies the air sucked into the engine 9, and the throttle body 29 injects fuel into the purified air having passed through the air cleaner 16 to form an air-fuel mixture and changes the flow rate of intake air (mixture) supplied to the engine 9.

The air cleaner 16 is disposed above the front half of the vehicle body frame 2. The air cleaner 16 is connected with the intake side of the engine 9 via the throttle body 29. The air cleaner 16 filters and purifies the intake air. The air cleaner 16 is sandwiched between the right and left main frames 22 in a vehicle plan view.

The throttle body 29 is provided between the air cleaner 16 and the engine 9. In the flow of the intake air supplied to the engine 9, the air cleaner 16 is connected with the upstream side of the throttle body 29 and the engine 9 is connected with the downstream side of the throttle body 29.

The fuel tank 12 is disposed above the front half of the body frame 2 and behind the air cleaner 16.

The seat 13 is disposed above the rear half of the body frame 2.

The cowling 15 covers and hides the body frame 2 from, e.g., the front portion to the central lower portion of the vehicle body. The cowling 15 has a streamline shape. The cowling 15 reduces air resistance during running of the motorcycle 1 and protects a rider from running wind pressure. The cowling 15 includes a front cover 30 covering the front portion of the motorcycle 1, a pair of right and left side covers 31 covering the side of the engine 9, an air cleaner cover 32 covering the air cleaner 16 and the fuel tank 12, and a rear cover 36 that supports the seat 13 and covers the rear of the motorcycle 1.

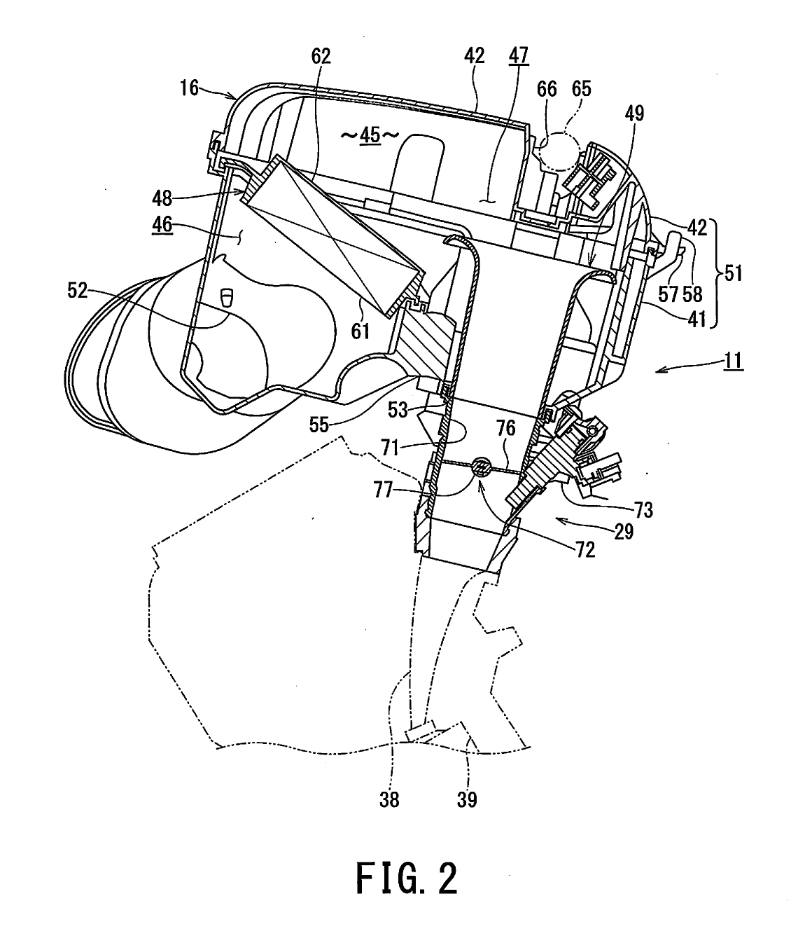

FIG. 2 is a longitudinal cross-sectional view of the intake system according to the embodiment of the present invention.

As shown in FIG. 2, the intake system 11 according to the embodiment of the present invention is connected with the intake ports 38 of the engine 9. The intake ports 38 are connected with corresponding combustion chambers 39. At least one intake port 38 and one combustion chamber 39 are provided for each cylinder. In the case of the embodiment of a parallel four-cylinder engine, there are four intake ports 38 and four combustion chambers 39.

The air cleaner 16 of the intake system 16 includes a housing 41, a lid 42 for closing the housing 41 and partitioning an internal space 45 of the air cleaner 16 together with the housing 41, and a filter 48 that is housed (i.e., accommodated) in the internal space 45 partitioned by the housing 41 and the lid 42 and divides the internal space 45 into a dirty side 46 and a clean side 47. By detaching the lid 42 from the housing 41, the air cleaner 16 can open the inner space 45 and detach the filter 48 from the housing 41 to replace the filter 48.

Further, the air cleaner 16 includes funnels 49 that are disposed on the downstream side of the filter 48, i.e., on the clean side 47 of the internal space 45 and allow the air having passed through the filter 48 to flow out from the internal space 45.

The combination of the housing 41 and the lid 42 is referred to as a cleaner box 51. The housing 41 includes inlets 52 for leading air to the dirty side 46 of the internal space 45 and outlets 53 for letting out air from the clean side 47 of the internal space 45. The inlets 52 are provided at the respective right and left corner portions on the front side of the housing 41. The outlets 53 are formed on the bottom wall of the rear half of the housing 41. One outlet 53 is provided for each cylinder (not shown) of the engine 9. In other words, the number of the outlets 53 is the same as the number of the cylinders of the engine 9. The outlets 53 are spatially connected with the engine through the throttle body 29.

A seat portion (i.e., base) 55 that supports the filter 48 is provided on the front half of the housing 41. The seat portion 55 is a boundary between the dirty side 46 and the clean side 47. When the seat portion 55 is set as the reference position, the side of the inlets 52 from the seat portion 55 is the dirty side 46 and the side of the outlets 53 from the seat portion 55 is the clean side 47. The seat portion 55 is inclined rearward and downward.

A pair of hooks 57 are provided in the rear of the lid 42. A pair of hook receivers 58 for hooking the corresponding hooks 57 of the lid 42 are provided in the rear of the housing 41.

The filter 48 includes a filter element 61 and a frame 62 that supports the filter element 61 on the housing 41. The filter element 61 filters the air flowing into the dirty side 46 of the internal space 45 of the housing 41, and causes the filtered air to flow out toward the clean side 47. The filter 48 is inclined rearward and downward following the inclination of the seat portion 55, and the same applies to the filter element 61.

The funnels 49 cause the air having passed through the filter 48 to flow out from the clean side 47 of the internal space 45. The funnels 49 lead the air purified in the air cleaner 16 to the throttle body 29.

The lid 42 includes a concave portion (i.e., recess) 66 that is recessed toward the inside of the lid 42 such that a fuel delivery pipe 65 can be disposed along the concave portion 66.

The concave portion 66 is disposed on the extension line of the funnels 49. The concave portion 66 extends in the width direction of the lid 42 and reaches the right and left side surfaces of the lid 42.

The fuel delivery pipe 65 is disposed on the extension line of the funnels 49. The fuel delivery pipe 65 is connected with a non-illustrated injector that injects fuel toward the funnels 49.

The throttle body 29 includes intake passages 71 connected to the corresponding intake ports 38. The throttle body 29 includes openable and closable throttle valves 72 provided for the corresponding intake passages 71 and injectors 73 for injecting fuel into the corresponding intake passages 71.

The upstream side of the intake passages 71 is connected with the funnels 49. The downstream side of the intake passages 71 is connected with the intake ports 38 of the engine 9. In other words, the funnels 49 are provided on the upstream side of the intake passages 71. The intake ports 38 of the engine 9 are provided on the downstream side of the intake passages 71.

The throttle valves 72 are a so-called butterfly valve. Each of the throttle valves 72 includes a disc-shaped valve body 76 for opening and closing the intake passage 71 and a valve shaft 77 for opening and closing the valve body 76.

The injectors 73 are provided in the corresponding intake passages 71 closer to the engine 9 than the corresponding throttle valves 72, i.e., provided in a portion of the corresponding intake passages 71 downstream of the corresponding throttle valves 72.

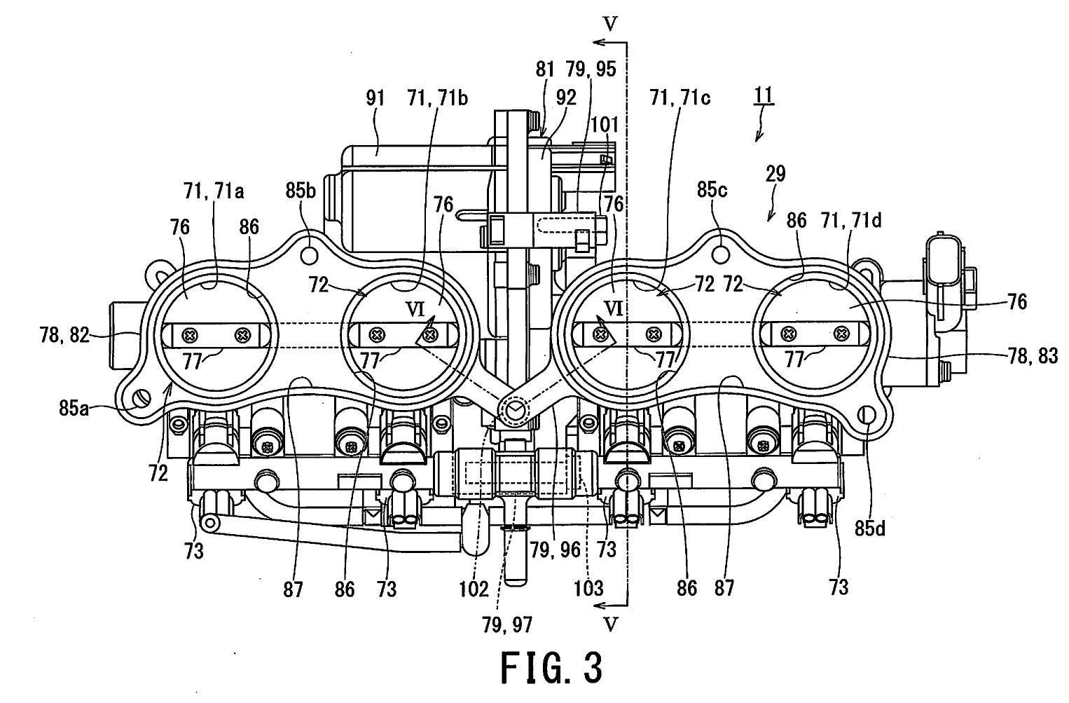

FIG. 3 is a plan view of the throttle body of the intake system according to the embodiment of the present invention.

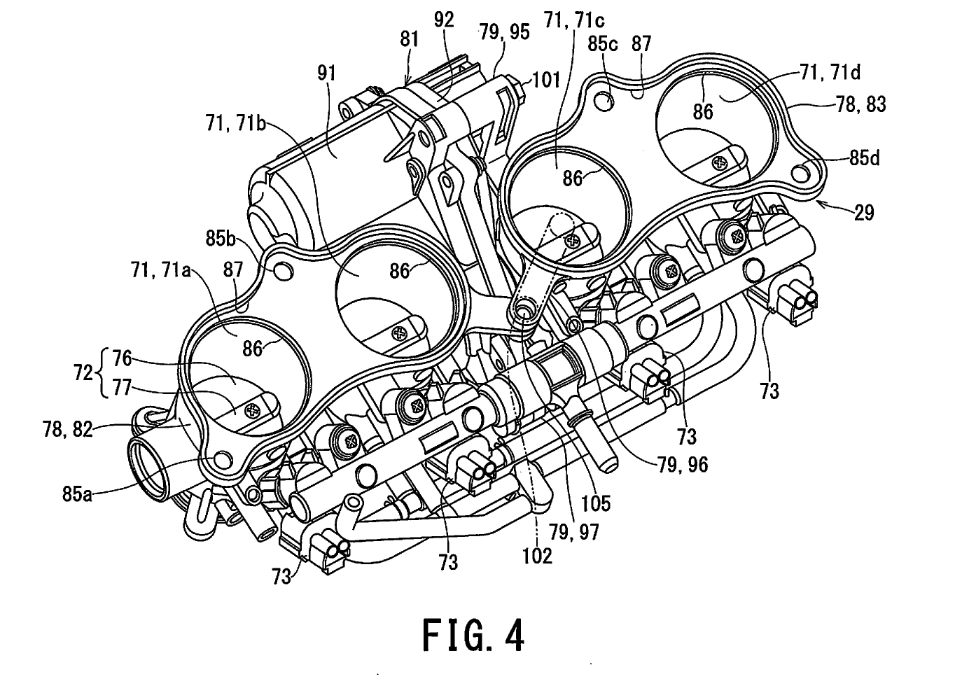

FIG. 4 is a perspective view of the throttle body of the intake system according to the embodiment of the present invention.

As shown in FIG. 3 and FIG. 4, the throttle body 29 of the intake system 11 according to the embodiment of the present invention includes the plural intake passages 71 adapted to the engine 9.

The throttle body 29 includes plural throttle body members 78 and plural structural connectors 79 provided in respective the throttle body members 78 for connecting the adjacent throttle body members 78 with each other. Each of the throttle body members 78 includes at least one intake passage 71. The throttle body 29 according to the present embodiment includes, e.g., two throttle body members 78, each of which includes two intake passages 71.

Further, the throttle body 29 includes a driver 81 for opening and closing the throttle valves 72.

For instance, there are four intake passages 71 (71a, 71b, 71c, 71d from the left side in FIG. 3), similarly to the number of cylinders of the engine 9. The plural intake passages 71 are arranged in the width direction of the throttle body 29, i.e., in the vehicle width direction of the motorcycle 1 and in the width direction of the engine 9.

Hereinafter, out of the plural, e.g., two throttle body members 78, the throttle body member 78 disposed on the left side of the motorcycle 1 is referred to as a left throttle body member 82 while the other throttle body member 78 disposed on the right side of the motorcycle 1 is referred to as a right throttle body member 83.

The left throttle body member 82 includes two circular and cylindrical intake passages 71a and 71b through which intake air flows, and two circular bolt holes 85a and 85b.

The two intake passages 71a and 71b are arranged in the width direction of the throttle body 29, i.e., in the vehicle width direction of the motorcycle 1 and in the width direction of the engine 9.

A stepped portion 86 is provided on the opening edge on the upstream side of each of the intake passages 71a and 71b. The lower end portions of the funnels 49 are fitted into (i.e., interdigitated with) the corresponding stepped portions 86.

The bolt holes 85a and 85b penetrate the left throttle body member 82. Non-illustrated bolts for fixing the air cleaner 16 to the throttle body 29 are tightened to (i.e., screwed into) the corresponding bolt holes 85a and 85b.

The bolt hole 85a is disposed at the outer edge portion of the left throttle body member 82 further on the far side from the intake passage 71a that is located at the furthest position from the right throttle body member 83. The bolt hole 85b is disposed between the two intake passages 71a and 71b and at the outer edge portion of the left throttle body member 82. The bolt holes 85a and 85b are respectively disposed on one side and the other side of the left throttle body member 82 with the valve shaft 77 interposed therebetween. One side of the throttle body members 78 is the front side of the throttle body members 78 and the other side of the throttle body members 78 is the rear side of the throttle body members 78. The bolt hole 85b is disposed on one side of the throttle body members 78 with reference to the valve shaft 77, i.e., on the front side of the throttle body members 78. Conversely, the bolt hole 85a is disposed on the other side of the throttle body members 78 with reference to the valve shaft 77, i.e., on the rear side of the throttle body members 78.

In addition, the left throttle body member 82 includes a rib 87 provided at the edge of the upstream end face. The rib 87 surrounds the end face on the upstream side of the left throttle body member 82. The air cleaner 16 includes a non-illustrated seal groove corresponding to the shape of the rib 87. A seal member, e.g., an O-ring (not shown) is fitted in the seal groove. When the throttle body 29 is fixed to the air cleaner 16, the rib 87 compresses the O-ring of the seal groove so as to create a seal at the interface.

The rib 87 surrounds a part of the periphery of the intake passages 71a and 71b and a part around the bolt holes 85a and 85b in an arc shape from the outside. The rib 87 extends continuously at the edge of the upstream end face of the left throttle body member 82.

The right throttle body member 83 includes two circular and cylindrical intake passages 71c and 71d through which intake air flows, and two circular bolt holes 85c and 85d.

The two intake passages 71c and 71d are arranged in the width direction of the throttle body 29, i.e., in the vehicle width direction of the motorcycle 1 and in the width direction of the engine 9.

The stepped portion 86 is also provided on the opening edge on the upstream side of each of the intake passages 71c and 71d. The lower end portions of the funnels 49 are fitted into (i.e., interdigitated with) the corresponding stepped portions 86.

The bolt holes 85c and 85d penetrate the right throttle body member 83. Non-illustrated bolts for fixing the air cleaner 16 to the throttle body 29 are tightened to (i.e., screwed into) the corresponding bolt holes 85c and 85d.

The bolt hole 85c is disposed between the two intake passages 71c and 71d and at the outer edge portion of the right throttle body member 83. The bolt hole 85d is disposed at the outer edge portion of the right throttle body member 83 further on the far side from the intake passage 71d that is located at the furthest position from the left throttle body member 82. The bolt holes 85c and 85d are respectively disposed on one side and the other side of the right throttle body member 83 with the valve shaft 77 interposed therebetween. One side of the throttle body members 78 (i.e., 82 and 83) is the front side of the throttle body members 78 and the other side of the throttle body members 78 is the rear side of the throttle body members 78. The bolt hole 85c is disposed on one side of the right throttle body member 83 with reference to the valve shaft 77, i.e., on the front side of the right throttle body member 83. Conversely, the bolt hole 85d is disposed on the other side of the right throttle body member 83 with reference to the valve shaft 77, i.e., on the rear side of the right throttle body member 83.

In addition, the right throttle body member 83 also includes the rib 87 provided at the edge of the upstream end face, similarly to the left throttle body member 82. The rib 87 of the right throttle body member 83 surrounds the end face on the upstream side of the right throttle body member 83. The air cleaner 16 includes another non-illustrated seal groove corresponding to the shape of the rib 87 of the right throttle body member 83, apart from the seal groove for the rib 87 of the left throttle body member 82. A seal member, e.g., an O-ring (not shown) is fitted in the seal groove of the right throttle body member 83. When the throttle body 29 is fixed to the air cleaner 16, the respective ribs 87 of the right and left throttle body members 83 and 82 compress the O-rings of the respective seal grooves so as to create a seal at each interface.

The rib 87 of the right throttle body member 83 surrounds a part of the periphery of the intake passages 71c and 71b and a part around the bolt holes 85c and 85d in an arc shape from the outside. The rib 87 extends continuously at the edge of the upstream end face of the right throttle body member 83.

The throttle valves 72 are provided inside the corresponding intake passages 71a, 71b, 71c, and 71d. The throttle valves 72 are a so-called butterfly valve. Each throttle valve 72 includes the disc-shaped valve body 76 for opening and closing the intake passage 71 and the valve shaft 77 for opening and closing the valve body 76. The valve bodies 76 are provided in the corresponding intake passages 71a, 71b, 71c, and 71d. The valve shafts 77 are provided for the corresponding throttle body members 78. The valve shafts 77 extends in the arrangement direction of the intake passages 71a and 71b or arrangement direction of the intake passages 71c and 71d, i.e., extends in the width direction of the throttle body members 78, and penetrates the corresponding throttle body members 78.

The driver 81 opens and closes the throttle valves 72 according to accelerator operation performed by a rider. The driver 81 includes an electric motor 91 that is connected with the valve shafts 77 of the throttle valves 72 and generates the opening and closing driving force of the valve bodies 76, a transmission mechanism for transmitting the driving force of the electric motor 91 to the valve shafts 77 of the throttle valves 72 (e.g., a non-illustrated speed reducer), and a casing 92 that houses the transmission mechanism.

The electric motor 91 generates the driving force according to accelerator operation performed by a rider so as to open and close the throttle valves 72.

The casing 92 is disposed between the adjacent throttle body members 78, i.e., between the right throttle body member 83 and the left throttle body member 82.

The plural structural connectors 79 include a pair of the structural connectors 79 that are connected with each other in directions different form each other.

The pair of the structural connectors 79 are arranged on one side and the other side of the throttle body members 78 with the valve shaft 77 interposed therebetween. One side of the throttle body members 78 is the front side of the throttle body members 78 and the other side of the throttle body members 78 is the rear side of the throttle body member 78. The pair of the structural connectors 79 include a first structural connector 95 connected in the arrangement direction of the adjacent throttle body members 78 and a second structural connector 96 connected in a direction different from the first connector 95.

The first structural connector 95 is disposed on one side of the throttle body members 78 with reference to the valve shaft 77, i.e., on the front side of the throttle body members 78. The first structural connector 95 includes a bolt 101 tightened in the arrangement direction of the adjacent throttle body members 78, i.e., in the width direction of the throttle body 29, and further includes a non-illustrated bolt hole for tightening the bolt 101.

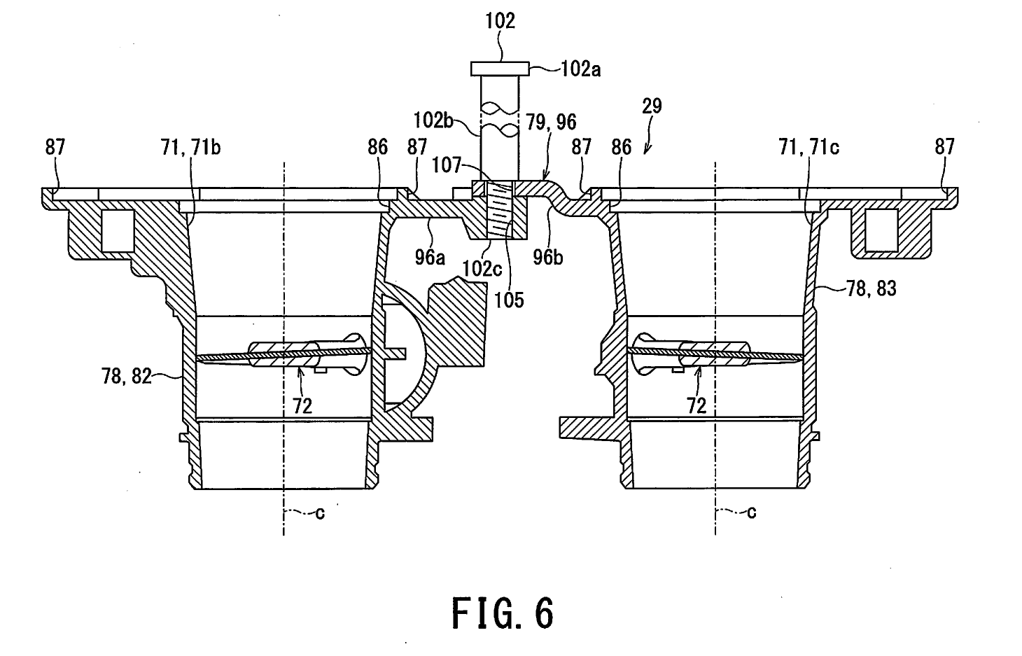

The second structural connector 96 is disposed on the other side of the throttle body members 78 with reference to the valve shaft 77, i.e., on the rear side of the throttle body members 78. The second structural connector 96 includes a bolt 102 tightened in a direction different from that of the first structural connector 95, e.g., in the direction orthogonal to the arrangement direction of the adjacent throttle body members 78, and further includes a bolt hole 105 (FIG. 4 and FIG. 6) for tightening the bolt 102.

That is, the tightening direction of the bolt 101 of the first structural connector 95 (i.e., the connection direction of the first structural connector 95) and the tightening direction of the bolt 102 of the second structural connector 96 (i.e., the connection direction of the second structural connector 96) are orthogonal to each other. More specifically, the inner product between the vector extending in the tightening direction of the bolt 101 of the first connector 95 and the vector extending in the tightening direction of the bolt 102 of the second connector 96 is zero.

The second structural connector 96 and the electric motor 91 are respectively arranged on one side and the other side of the throttle body members 78 with the valve shaft 77 interposed therebetween. That is, the first structural connector 95 and the electric motor 91 are disposed on one side of the throttle body members 78 with reference to the valve shaft 77.

In addition, the plural structural connectors 79 further include a third structural connector 97 that is connected in the same direction as the first structural connector 95. The third connector 97 is disposed on the opposite side of the throttle body members 78 with the valve shaft 77 interposed therebetween as viewed from the first structural connector 95. That is, the third structural connector 97 is disposed at the rear side of the throttle body members 78, similarly to the second structural connector 96.

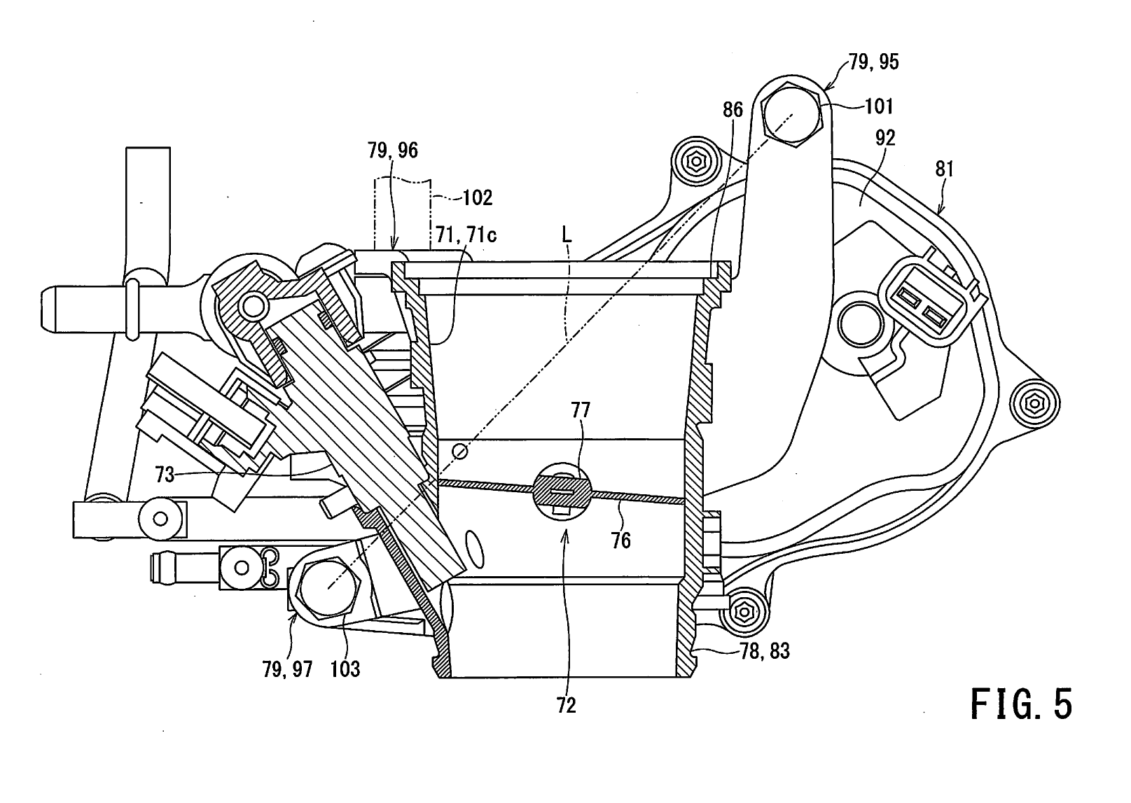

The third structural connector 97 includes a bolt 103 (FIG. 3 and FIG. 5) tightened in the arrangement direction of the adjacent throttle body members 78, i.e., in the width direction of the throttle body 29, and further includes a non-illustrated bolt hole for tightening the bolt 103.

The bolt hole 105 of the second structural connector 96 and the bolt holes 85a, 85b, 85c, 85d of the throttle body members 78 are disposed on the front side and the rear side of the throttle body members 78 with the valve shaft 77 interposed therebetween. The bolt hole 85b of the left throttle body member 82 and the bolt hole 85c of the right throttle body member 83 are disposed on the front side of the right and left throttle body members 83 and 82. The bolt hole 105 of the second structural connector 96, the bolt hole 85a of the left throttle body member 82, and the bolt hole 85d of the right throttle body member 83 are disposed on the rear side of the right and left throttle body members 83 and 82.

FIG. 5 is a cross-sectional view of the throttle body of the intake system according to the embodiment of the present invention, taken along the line V-V in FIG. 3. Note that, the line V-V extends in the longitudinal direction of the motorcycle 1.

As shown in FIG. 5, the throttle body 29 according to the embodiment of the present invention is provided with the plural structural connectors 79 that include at least the first structural connector 95, the second structural connector 96, and the third structural connector 97.

The first structural connector 95 is disposed on the upstream side of the throttle body 29 from the valve shafts 77 of the throttle valves 72.

The third structural connector 97 is disposed on the downstream side of the throttle body 29 from the valve shafts 77 of the throttle valves 72.

The second structural connector 96 is disposed on the upstream side of the throttle body members 78 from a line L that passes through the first structural connector 95 and the third structural connector 97. That is, the second structural connector 96 is disposed on the upstream side of the throttle body 29 from the line L that passes through the first structural connector 95 and the third structural connector 97 that are connected in the same direction. In other words, the second structural connector 96 is disposed in the region closer to the air cleaner 16 than the engine 9, among the regions divided by the line L.

The line L is a straight line that passes through the center of the bolt 101 or the bolt hole of the first structural connector 95 and the center of the bolt 103 or the bolt hole of the third structural connector 97.

FIG. 6 is a cross-sectional view of the throttle body of the intake system according to the embodiment of the present invention, taken along the line VI-VI in FIG. 3.

As shown in FIG. 6, one of the pair of the structural connectors 79 of the throttle body 29 according to the embodiment of the present invention, i.e., the second structural connector 96 includes the connecting member (e.g., bolt 102) for fixing the throttle body members 78 to the air cleaner 16 and connecting the adjacent throttle body members 78 with each other, and the bolt hole 105 for tightening the bolt 102. In other words, the bolt 102 tightens the air cleaner 16, the left throttle body member 82, and the right throttle body member 83 together so as to integrate these three components.

The bolt 102 is tightened in the direction that is substantially orthogonal to the tightening direction of the bolt 101 of the first structural connector 95 and the bolt 103 of the third structural connector 97 (i.e., the connection direction of the first structural connector 95 and the third structural connector 97) and is parallel to the center line C of each intake passage 71. The bolt 102 penetrates the funnels 49 of the air cleaner 16 and the housing 41, and is tightened to the bolt hole 105.

In addition, the bolt 102 is a so-called shoulder bolt (i.e., stepped bolt). The bolt 102 includes a bolt head 102a, an unthreaded shank 102b connected with the bolt head 102a, and a threaded portion 102c connected with the unthreaded shank 102b. The diameter of the unthreaded shank 102b is larger than the diameter of the threaded portion 102c. The bolt 102 sandwiches the funnels 49 and the housing 41 between the bolt head 102a and the second structural connector 96, and connects the second structural connector 96 with the threaded portion 102c. The unthreaded shank 102b is slightly shorter than the thickness of each funnel 49 and the housing 41. Thus, when the threaded portion 102c is tightened in the bolt hole 105 of the second structural connector 96, the bolt 102 presses each funnel 49 and the housing 41 against the throttle body 29 such that the funnels 49, the housing 41, and the throttle body 29 are integrated.

The second structural connector 96 includes a second-connector left half 96a provided in the left throttle body member 82 and a second-connector right half 96b provided in the right throttle body member 83. Either one of the second-connector left half 96a or the second-connector right half 96b, e.g., the second-connector right half 96b includes a through hole 107 through which the threaded part 102c of the bolt 102 passes. The other of the second-connector left half 96a and the second-connector right half 96b, e.g., the second-connector left half 96a includes the bolt hole 105. The second-connector right half 96b has a bearing surface against which the unthreaded shank 102b of the bolt 102 abuts.

The second-connector left half 96a protrudes from the left throttle body member 82, and the second-connector right half 96b protrudes from the right throttle body member 83. The second-connector left half 96a and the second-connector right half 96b are also integrated with the corresponding bases (i.e., root) of the ribs 87 in addition to the corresponding main body of the throttle body members 78. It is sufficient that one of the second-connector left half 96a and the second-connector right half 96b is integrated with the corresponding bases of the ribs 87.

The second-connector left half 96a and the second-connector right half 96b extend along a virtual line that extends radially outward from the center of the nearest intake passage 71. The bolt 102 connects the second-connector left half 96a and the second-connector right half 96b with each other at the intermediate position between the left throttle body member 82 and the right throttle body member 83 in the arrangement direction of the intake passages 71.

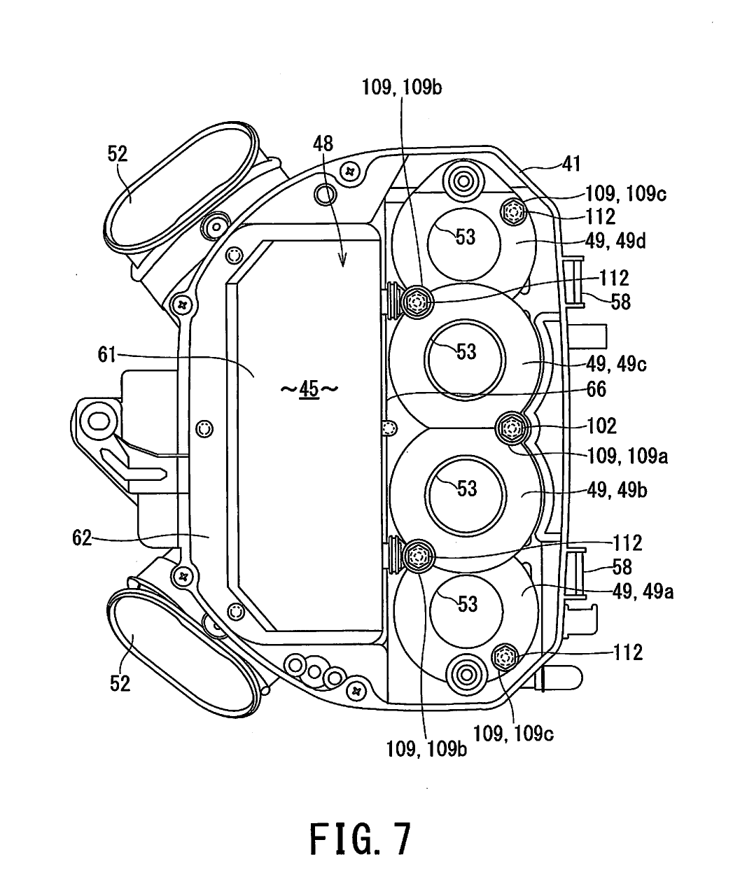

FIG. 7 is a plan view illustrating the state in which the lid of the air cleaner of the motorcycle according to the embodiment of the present invention is opened.

As shown in FIG. 7, the air cleaner 16 of the motorcycle 1 according to the embodiment of the present invention includes plural, e.g., four funnels 49 that are arranged on the downstream side of the filter 48 and allow the air having passed through the filter 48 to flow out from the internal space 45.

For instance, there are four funnels 49, similarly to the number of cylinders of the engine 9. In other words, the number of funnels 49 is the same as the number of the intake passages 71 of the throttle body 29. The plural funnels 49 are arranged in the width direction of the air cleaner 16, i.e., in the vehicle width direction of the motorcycle 1 and in the width direction of the engine 9.

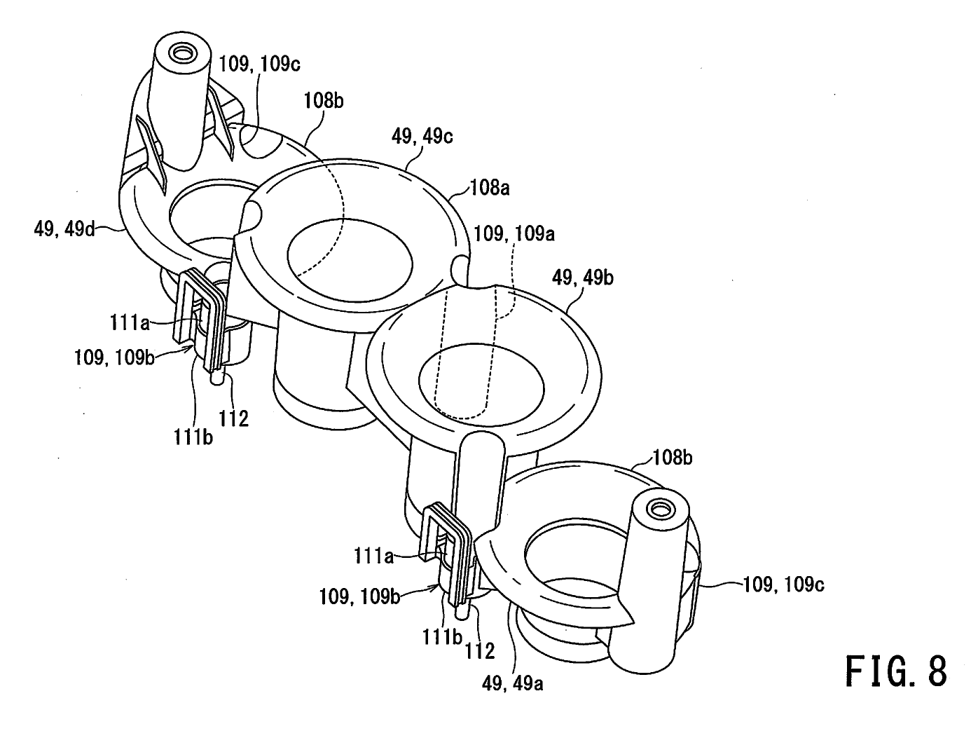

FIG. 8 is a perspective view of the funnels of the air cleaner of the motorcycle according to the embodiment of the present invention.

As shown in FIG. 2, FIG. 7, and FIG. 8, the funnels 49 of the air cleaner 16 according to the embodiment of the present invention are separate components from the housing 41 and the lid 42. The funnels 49 are provided on the bottom surface of the rear half of the housing 41. The funnels 49 and the housing 41 are tightened together with the throttle body 29 by the bolt 102 that penetrates the funnels 49 and the housing 41 and is tightened to the throttle body 29.

The funnels 49 are provided for the corresponding outlets 53 of the cleaner box 51 (i.e., combination of the housing 41 and the lid 42 as defined above). That is, one funnel 49 is also provided for each cylinder (not shown) of the engine 9, similarly to the outlets 53 of the cleaner box 51. The number of the funnels 49 is the same as the number of the cylinders of the engine 9. For instance, the engine 9 according to this embodiment is a parallel four-cylinder engine, and the plural outlets 53 and the plural funnels 49 are arranged in a straight line.

The funnels 49 are connected with the corresponding outlets 53 of the housing 41 and protrude toward the clean side 47 of the internal space 45. The funnels 49 include funnels 49 having different amounts of protrusion from the bottom surface of the housing 41. The central two funnels 49b and 49c have larger protrusion than the right and left two funnels 49d and 49a. In addition, the central two funnels 49b and 49c reach the same height as the filter element 61, and the right and left two funnels 49d and 49a are lower in height than the filter element 61.

The funnels 49 are divided into plural funnel members 108. For instance, the central two funnels 49b and 49c constitute an integrated funnel member 108a. Each of the right and left funnels 49d and 49a is a single funnel member 108b. The single funnel members 108b are integrated with the central funnel member 108a.

The funnels 49 include a total of, e.g., five bosses 109, in each of which the bolt 102 or 112 is disposed.

The bosses 109 are arranged between a pair of adjacent funnels 49. More specifically, in the case of FIG. 8, the five bosses 109 include one boss 109a, two bosses 109b, and two bosses 109c. The boss 109a is disposed between the central two funnels 49b and 49c having larger dimension in height. One of the two bosses 109b is disposed between the central-side funnel 49b and the end-side funnel 49a having smaller dimension in height, while the other of the two bosses 109b is disposed between the central-side funnel 49c and the end-side funnel 49d having smaller dimension in height. The respective two bosses 109c are provided for the pair of end-side funnels 49a and 49d.

The bolt 102 for fixing the throttle body members 78 to the air cleaner 16 and connecting the adjacent throttle body members 78 with each other is disposed in the central boss 109a.

Each of the bosses 109b includes an upper inner boss portion 111a provided in the tall funnel 49b or 49c and a lower outer boss portion 111b provided in the lower funnel 49a or 49d. The upper inner boss portion 111a is fitted into (i.e., interdigitated with) the lower outer boss portion 111b to integrate the plural funnels 49.

The bolt 112 tightened to the bolt hole 85b of the left throttle body member 82 is disposed on the left boss 109b. The bolt 112 tightened to the bolt hole 85c of the right throttle body member 83 is disposed on the right boss 109b.

In the left boss 109c, the bolt 112 tightened to the bolt hole 85a of the left throttle body member 82 is disposed. In the right boss 109c, the bolt 112 tightened to the bolt hole 85d of the right throttle body member 83 is disposed.

The bolts 112 pass through the corresponding bosses 109 of the funnels 49 and the bottom plate of the housing 41 of the air cleaner 16, and are tightened to the throttle body 29. The bolts 102 and 112 are arranged so as to fit the bolt hole 105 of the second connector 96 and the bolt holes 85a, 85b, 85c, 85d of the throttle body 29. That is, the two bolts 112 tightened to the corresponding bolt holes 85b and 85c are disposed on the front side of the funnels 49. The bolt 102 of the second connector 96 and the two bolts 112 tightened to the corresponding bolt holes 85a and 85d are disposed on the rear side of the funnels 49.

The plural funnels 49 are not limited to the above-described aspect in which the funnels 49 are divided into an integrated member composed of the two central funnels 49b and 49c, a single funnel 49a on the left-side end portion, and a single funnel 49d on the right-side end portion. For instance, each of the four funnels 49 may be a single member. In addition, all the funnels 49 may be configured such that the two funnels 49a and 49b on the left side constitute an integrated funnel member 108, the two funnels 49c and 49d on the right side constitute another integrated funnel member 108, and these two funnel members 108 are combined at the central portion of the funnels 49. Regardless of the division method for the funnels 49, the bolt 102 for fixing the throttle body members 78 to the air cleaner 16 and connecting the adjacent throttle body members 78 with each other integrates the plural funnel members 108.

The intake system 11 of the motorcycle 1 according to the present embodiment includes the pair of the structural connectors 79 that are connected in directions different from each other and connect the adjacent throttle body members 78 with each other. Consequently, the intake system 11 of the motorcycle 1 strengthens the connection of the adjacent throttle body members 78, and thereby improves the rigidity of the throttle body 29.

Additionally, the intake system 11 of the motorcycle 1 according to the present embodiment includes the pair of the structural connectors 79 that are disposed on one side and the other side of the throttle body members 78 with the valve shaft 77 of each of the throttle valves 72 interposed therebetween. Consequently, the intake system 11 of the motorcycle 1 further strengthens the connection of the adjacent throttle body members 78, and further enhances the rigidity of the throttle body 29.

Further, the intake system 11 of the motorcycle 1 according to the present embodiment includes the first structural connector 95 connected in the arrangement direction of the adjacent throttle body members 78. Consequently, the intake system 11 of the motorcycle 1 increases the rigidity of the throttle body 29 by making the connection of the adjacent throttle body members 78 stronger, while ensuring ease of assembling the adjacent throttle body members 78.

Moreover, the intake system 11 of the motorcycle 1 according to the present embodiment includes the second structural connector 96 that is disposed on the upstream side of the throttle body members 78 from the line L that passes through the first structural connector 95 and the third structural connector 97. Consequently, the intake system 11 of the motorcycle 1 can effectively suppress the vibration mode of the throttle body 29 that is vibrated to bend around the line L that passes through the first structural connector 95 and the third structural connector 97.

Furthermore, the intake system 11 of the motorcycle 1 according to the present embodiment includes the bolt 102 for fixing the throttle body members 78 to the air cleaner 16 and connecting the adjacent throttle body members 78 with each other. Consequently, the intake system 11 of the motorcycle 1 improves the rigidity of the intake system 11 by further strengthening the connection of the entire intake system 11 that includes the air cleaner 16 in addition to the throttle body 29.

Additionally, the intake system 11 of the motorcycle 1 according to the present embodiment includes the second structural connector 96 that connects the bases of the corresponding ribs 87 of the adjacent throttle body members 78. Consequently, the intake system 11 of the motorcycle 1 further strengthens the connection of the adjacent throttle body members 78 so as to improve the rigidity of the throttle body 29.

Further, the intake system 11 of the motorcycle 1 according to the present embodiment includes the bolt 102 for fixing the throttle body members 78 to the air cleaner 16 and integrating the plural funnel members 108. When the second structural connector 96 is simply added in addition to the first structural connector 95 and the third structural connector 97 connected in the same direction, the intake system 11 of the motorcycle 1 is accompanied by an increase in the number of components including the bolt 102. For this reason, the intake system 11 of the motorcycle 1 uses the bolt 102 for integrating the plural funnel members 108 and suppresses an increase in the number of components.

Moreover, the intake system 11 of the motorcycle 1 according to the present embodiment includes the second structural connector 96 disposed on one side and the other side of the throttle body members 78 with the valve shaft 77 interposed therebetween and the electric motor 91. Consequently, the intake system 11 of the motorcycle 1 can easily secure the installation area (installation place) of the electric motor 91.

Furthermore, the intake system 11 of the motorcycle 1 according to the present embodiment includes the second structural connector 96 that is connected in the direction substantially orthogonal to the connection direction of the first connector 95. Consequently, the intake system 11 of the motorcycle 1 sufficiently strengthens the connection of the adjacent throttle body members 78, and thereby improves the rigidity of the throttle body 29.

According to the intake system of the motorcycle 1 of the present embodiment as described above, it is possible to improve rigidity of the throttle body 29 by strengthening the connection between the plural throttle body members 78 equipped with the intake passages 71 and further stabilize the opening degree of the throttle body 29.

1. An intake system of an internal combustion engine comprising:
a plurality of throttle body members, each having at least one intake passage; and
a plurality of structural connectors that are provided on respective throttle body members and connect adjacent the throttle body members with each other,
wherein the plurality of structural connectors includes a pair of structural connectors that are connected with each other in directions different from each other.

2. The intake system of an internal combustion engine according to claim 1, further comprising:
a valve body configured to open and close the intake passage; and
a valve shaft configured to drive the valve body,
wherein the pair of structural connectors are disposed on one side and another side of the throttle body members with the valve shaft interposed between the pair of connectors.

3. The intake system of an internal combustion engine according to claim 1, wherein the pair of structural connectors include a first structural connector connected in an arrangement direction of the adjacent throttle body members and a second structural connector connected in a direction different from the first connector.

4. The intake system of an internal combustion engine according to claim 3, wherein the plurality of structural connectors further include a third structural connector connected in a same direction as the first structural connector; and
wherein the second structural connector is disposed on an upstream side of the throttle body members from a line that passes through the first structural connector and the third structural connector.

5. The intake system of an internal combustion engine according to claim 1, further comprising an air cleaner box connected with an upstream side of the intake passages,
wherein one of the pair of structural connectors includes a connecting member that fixes the adjacent throttle body members to the air cleaner box and connects the adjacent throttle body members with each other.

6. The intake system of an internal combustion engine according to claim 1, further comprising:
an air cleaner box connected with an upstream side of the intake passages; and
a plurality of funnels that are provided on an upstream sides of the corresponding intake passages,
wherein the plurality of funnels are divided into a plurality of funnel members; and
wherein one of the pair of structural connectors includes a connecting member that fixes the adjacent throttle body members to the air cleaner box and integrates the plurality of funnel members together.

7. The intake system of an internal combustion engine according to one of claim 1, further comprising a plurality of ribs provided on respective edge portions of upstream-side end faces of the throttle body members,
wherein at least one of the pair of structural connector connects a base of each of the ribs of the adjacent throttle body members.

8. The intake system of an internal combustion engine according to claim 1, further comprising:
a valve body configured to open and close the intake passage;
a valve shaft configured to drive the valve body; and
an electric motor that is connected with the valve shaft and generates an opening and closing driving force of the valve body,
wherein the second structural connector and the electric motor are respectively disposed on one side and another side of the throttle body members with the valve shaft interposed between the second structural connector and the electric motor.

9. The intake system of an internal combustion engine according to claim 1,
wherein a connection direction of the first structural connector and a connection direction of the second structural connector is substantially orthogonal to each other.

10. The intake system of an internal combustion engine according to claim 2, further comprising an air cleaner box connected with an upstream side of the intake passages,
wherein one of the pair of structural connectors includes a connecting member that fixes the adjacent throttle body members to the air cleaner box and connects the adjacent throttle body members with each other.

11. The intake system of an internal combustion engine according to claim 3, further comprising an air cleaner box connected with an upstream side of the intake passages,
wherein one of the pair of structural connectors includes a connecting member that fixes the adjacent throttle body members to the air cleaner box and connects the adjacent throttle body members with each other.

12. The intake system of an internal combustion engine according to claim 4, further comprising an air cleaner box connected with an upstream side of the intake passages,
wherein one of the pair of structural connectors includes a connecting member that fixes the adjacent throttle body members to the air cleaner box and connects the adjacent throttle body members with each other.

13. The intake system of an internal combustion engine according to claim 2, further comprising an air cleaner box connected with an upstream side of the intake passages,
wherein one of the pair of structural connectors includes a connecting member that fixes the adjacent throttle body members to the air cleaner box and connects the adjacent throttle body members with each other.

14. The intake system of an internal combustion engine according to claim 3, further comprising:
an air cleaner box connected with an upstream side of the intake passages; and
a plurality of funnels that are provided on an upstream sides of the corresponding intake passages,
wherein the plurality of funnels are divided into a plurality of funnel members; and
wherein one of the pair of structural connectors includes a connecting member that fixes the adjacent throttle body members to the air cleaner box and integrates the plurality of funnel members together.

15. The intake system of an internal combustion engine according to claim 4, further comprising:
an air cleaner box connected with an upstream side of the intake passages; and
a plurality of funnels that are provided on an upstream sides of the corresponding intake passages,
wherein the plurality of funnels are divided into a plurality of funnel members; and
wherein one of the pair of structural connectors includes a connecting member that fixes the adjacent throttle body members to the air cleaner box and integrates the plurality of funnel members together.

16. The intake system of an internal combustion engine according to claim 2, further comprising a plurality of ribs provided on respective edge portions of upstream-side end faces of the throttle body members,
wherein at least one of the pair of structural connector connects a base of each of the ribs of the adjacent throttle body members.

17. The intake system of an internal combustion engine according to claim 3, further comprising a plurality of ribs provided on respective edge portions of upstream-side end faces of the throttle body members,
wherein at least one of the pair of structural connector connects a base of each of the ribs of the adjacent throttle body members.

18. The intake system of an internal combustion engine according to claim 4, further comprising a plurality of ribs provided on respective edge portions of upstream-side end faces of the throttle body members,
wherein at least one of the pair of structural connector connects a base of each of the ribs of the adjacent throttle body members.

19. The intake system of an internal combustion engine according to claim 5, further comprising a plurality of ribs provided on respective edge portions of upstream-side end faces of the throttle body members,
wherein at least one of the pair of structural connector connects a base of each of the ribs of the adjacent throttle body members.

20. The intake system of an internal combustion engine according to claim 6, further comprising a plurality of ribs provided on respective edge portions of upstream-side end faces of the throttle body members,
wherein at least one of the pair of structural connector connects a base of each of the ribs of the adjacent throttle body members.
